(19) United States
(12) Patent Application Publication
(10) Pub. No.: US 2015/0110552 A1
(43) Pub. Date: Apr. 23, 2015

(54) Concealable Clamping System for Mounting Partitions

(71) Applicant: Fei Yang, Qingdao (CN)

(72) Inventor: Fei Yang, Qingdao (CN)

(73) Assignee: Qingdao Jinfer International Trading Co., Ltd, Qingdao (CN)

(21) Appl. No.: 14/058,337

(22) Filed: Oct. 21, 2013

(51) Int. Cl. F16B 2/14

(52) U.S. Cl. CPC F16B 2/14
USPC 403/374.1

(57) ABSTRACT

A concealable clamping system for mounting partitions comprising at least one clamping units, wherein each clamping unit comprises: a base with an opening to receive an edge portion of a partition, at lease one receiving plate fitted inside of the opening of the base to orient the edge portion of the partition, at least one adjustable wedge to secure the edge portion of the partition against the receiving plate and against an inner surface of the base, at least one concealing strip fitted between the edge of the base and the partition.

### CROSS-REFERENCES TO RELATED APPLICATIONS

None

### TECHNICAL FIELD

The present invention, in some embodiments thereof, relates to clamping systems for mounting partitions.

### BACKGROUND OF THE INVENTION

Indoor or outdoor railings, for instance installed along stairways or balconies, often employs opaque, transparent, or translucent partition materials to delineate space with specific designs. Partitions materials, with extended surface area, can be mounted directly onto the edge or side of the railings, or on the ground. The installation of partition materials must take into account various constrains imposed by the design itself, as well as by physical conditions such as the expansion or shrinkage of the material due to temperature change, weather exposure and etc. Therefore, flexibility and security are two main concerns for such installation.

Various clamping systems have been invented for mounting partitions, such as those described in a family of patents related to U.S. Pat. No. 8,181,405 B2. The clamping systems disclosed in these patents are for installing partitions on the ground. They lack the ability to prevent debris from falling into the installation.

The present invention can be installed both on the ground or vertically upright along either outer surface of the base. It can be installed with an extended base, or as single units to accommodate complex designs. It comprises a concealing mechanism to prevent debris from clogging the clamps, as well as to improve the esthetic appeal of the partition by not showing the mechanics of the clamps, and prevent tempering.

### BRIEF SUMMARY OF EMBODIMENTS OF THE INVENTION

The present invention relates to clamping systems for mounting partitions.

In a variant, the clamping system comprises a base with an opening to receive an edge portion of a partition, at lease one receiving plate fitted inside of the opening of the base to orient the edge portion of the partition, at least one adjustable wedge to secure the edge portion of the partition against the receiving plate and against an inner surface of the base, a first removable concealing strip fitted between a first edge of the base and the partition, and a second removable concealing strip fitted between a second edge of the base and the partition.

In another variant, the base further comprises an outer surface with an U shaped profile configured to have a bottom surface and two side walls that are generally parallel to one another, and an inner surface with a V shaped profile configure to have a bottom surface and two side walls that converge towards the base.

In still another variant, a first inner edge along the opening of the base comprises at least one protrusion to receive the first removable concealing strip, and a second inner edge along the opening of the base comprises at least one protrusions to receive the second removable concealing strip.

In yet another variant, the protrusions on the inner edges of the base and the concealing strips are configured with profiles that are geometrically inverse of one another, so as to retain the concealing strips in their respective positions.

In yet a further variant, the first and second concealing strips further comprise at least one tentacle.

Optionally, the first and second concealing strips further comprise at least one cutout to increase flexibility during installation.

In a variant, the receiving plate further comprises a long arm with generally an up-side-down triangular profile towards the bottom surface of the base, and a short arm with an arch creating a channel between the short arm and the bottom surface of the inner surface of the base.

In another variant, the orientation of the partition can be selectively adjusted by changing the triangular profile of the long arm of the receiving plate.

In still another variant, the long arm of the receiving plate further comprise at least one cut out to increase flexibility during installation.

In yet a further variant, the adjustable wedge is installed between the edge portion of the partition and the side wall of the inner surface of the base.

Optionally, the adjustable wedge further comprises an upper block and a lower block jointly held together by a screw housed in the upper block and a receiving nut housed in the lower block.

In a variant, a width of the wedge is determined by sliding the upper block against the lower block by adjusting specific positions of the screw with respect to the nut along a predetermined path.

In another variant, the partition can be selectively angled by adjusting the width of the wedge against the long arm of the receiving plate along various locations.

In still another variant, the base can be installed to receive either a horizontal or a vertical edge of a partition.

In yet another variant, clamping system for mounting partitions comprising multiple clamping units, wherein each clamping unit comprises: a base with an opening to receive an edge portion of a partition, at lease one receiving plate fitted inside of the opening of the base to orient the edge portion of the partition, at least one adjustable wedge to secure the edge portion of the partition against the receiving plate and against an inner surface of the base, a first removable concealing strip fitted between a first edge of the base and the partition, and a second removable concealing strip fitted between a second edge of the base and the partition.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiment of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

The present invention, in accordance with one or more various embodiments, is described in detail with reference to the following figures. The drawings are provided for purposes of illustration only and to merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1A is a schematic drawing which illustrates a two-dimensional cross section of a clamping system viewed from the side, according to some embodiments of the present invention;

FIG. 1B is a schematic drawing which illustrates a three-dimensional perspective view of the clamping system, with cut outs to reveal the inner layers of the system, according to some embodiments of the present invention;

FIG. 2A is a schematic drawing of a two-dimensional cross-section of a base for the clamping system viewed from the side, according to some embodiments of the present invention;

FIG. 2B is a schematic drawing which illustrates a three-dimensional perspective view of the base, according to some embodiments of the present invention;

FIG. 3A is a schematic drawing which illustrates a three-dimensional perspective view of the receiving plate, according to some embodiments of the present invention;

FIG. 3B is a is a schematic drawing which illustrates a two-dimensional cross section of a clamping system viewed from the side, with the partition installed with an angle.

FIG. 4A is a schematic drawing which illustrates a frontal view of the wedge, according to some embodiments of the present invention;

FIG. 4B is a schematic drawing which illustrates a side view of the wedge, according to some embodiments of the present invention.

FIG. 5A is a schematic drawing which illustrates the width of the wedge with the screw in a raised position.

FIG. 5B is a schematic drawing which illustrates the width of the wedge with the screw in a lowered position.

FIG. 6 is a schematic drawing which illustrates the side view of the upper edges of the base with the partition and both concealing strips in place.

FIG. 7 is a schematic drawing which illustrates a three-dimensional perspective view of the clamping system in an upright position, securing the partition from both sides.

FIG. 8 illustrates an example where a partition with complex designs is accommodated with multiple clamping units.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE OF THE INVENTION

From time-to-time, the present invention is described herein in terms of example environments. Description in terms of these environments is provided to allow the various features and of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention, in some embodiments thereof, relates to clamping systems for mounting partitions.

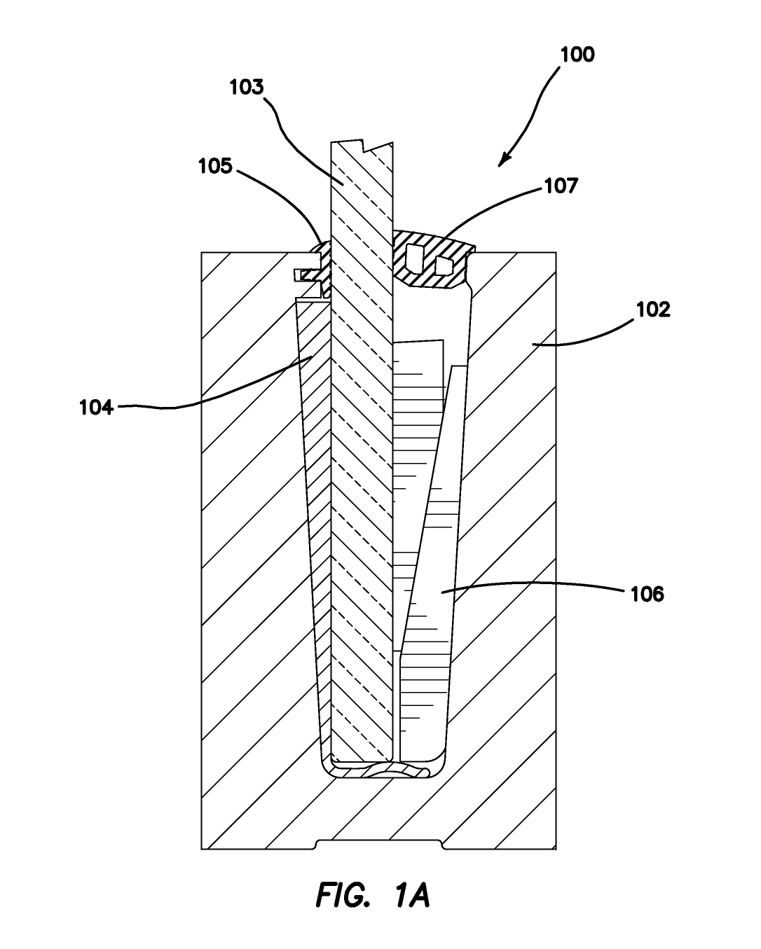

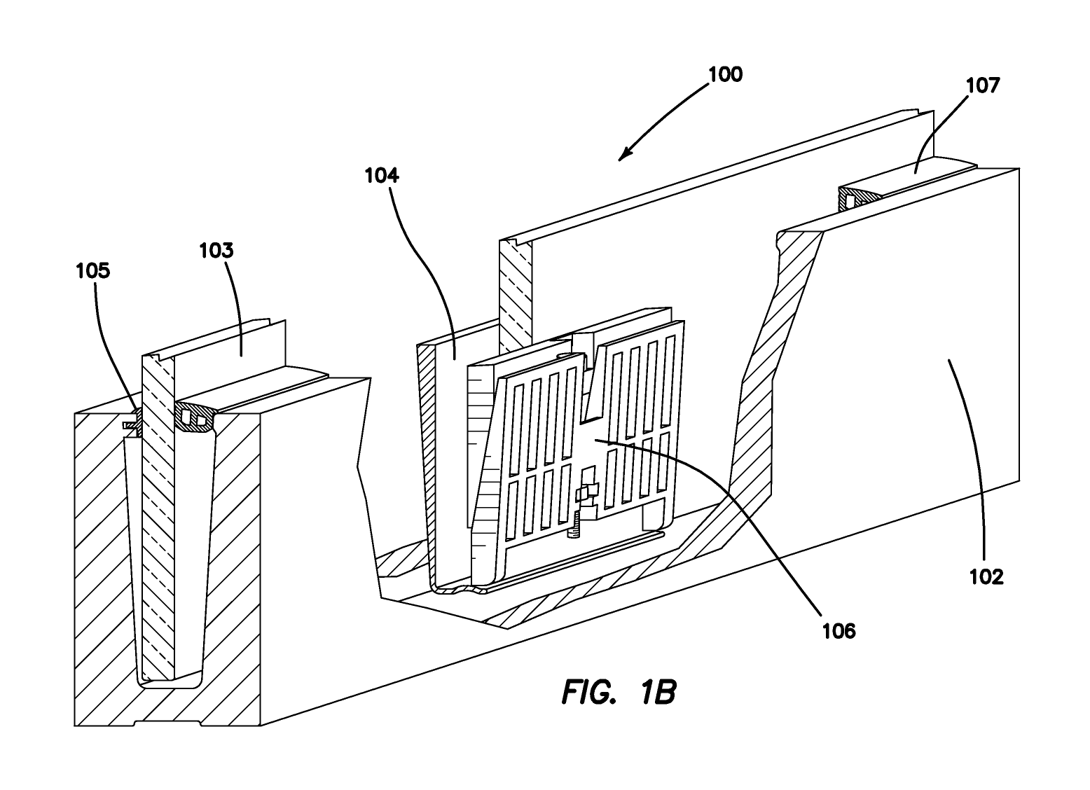

FIG. 1A illustrates a two-dimensional cross section of a clamping system 100 viewed from the side. FIG. 1B illustrates a three-dimensional perspective view, with cut outs to expose the inner layers, of the clamping system 100.

The clamping system 100 comprises a base 102. A receiving plate 104 is fitted into the opening of the base 102. A portion of a partition 103 is inserted into the base 102, and resting on the receiving plate 104. An adjustable wedge device 106 is inserted between the inner surface of the base and the partition. The thickness of the wedge 106 is adjusted to engage the inner surface of the base and the partition with enough surface pressure, so that a portion of the partition 103 is lodged inside of the base 103, and can not be easily removed.

In an exemplary embodiment illustrated in FIG. 1, the clamping system is resting on a horizontal surface, and the opening of the base 102 is facing upward. The space between the partition 103 and the base is wide open, therefore subject to receive and collect liquid or solid debris from either natural weather or from human activity. The exposure of the wedge also invites unwanted tempering by unauthorized personnel. Two concealing strips 105 and 107 are inserted between the partition 103 and the base 102 along the opening edges of the base. The purpose of the concealing strips are to reduce the problems due to exposure and the possibility of tempering. The strips also improve the overall esthetic of the railing assembly by shielding the visibility of the inner mechanics of the clamping system for the partition.

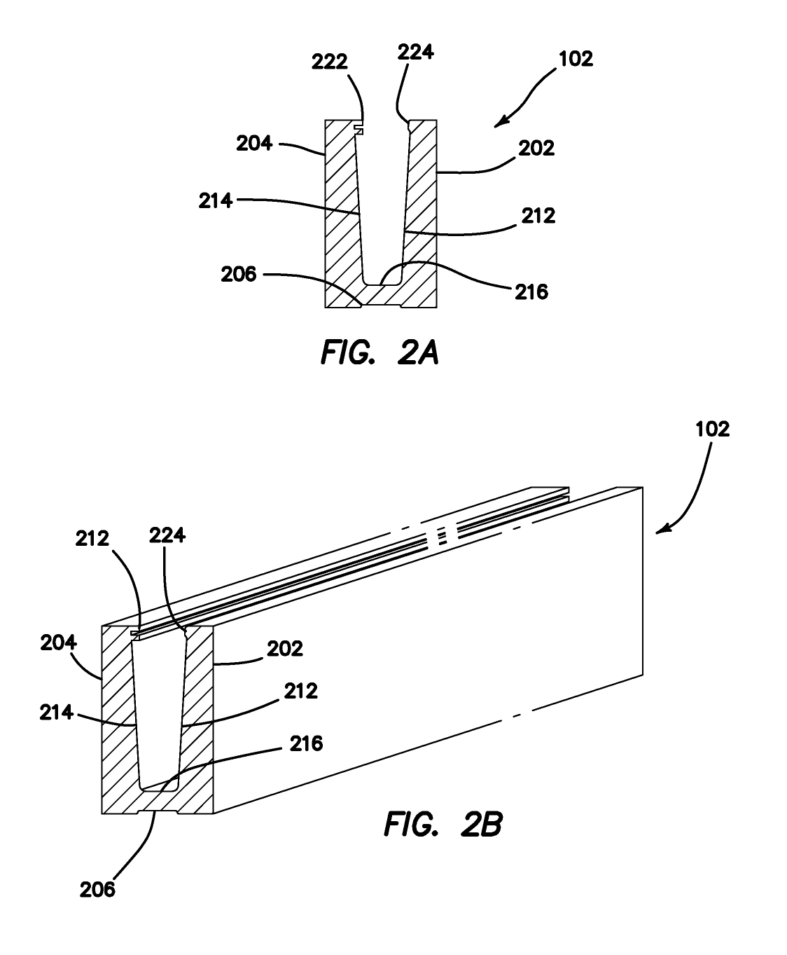

FIG. 2A illustrates a two-dimensional side view of a base 102. FIG. 2B illustrates a perspective view of the base 102.

The base 102 can be manufactured from relatively hard and dense material, so that it's rigidity and weight can receive and support a partition inserted into the opening of the base. The base 102 comprises an outer surface and an inner surface. FIG. 2A illustrates the outer surfaces 202, 204, and 206 in a U shaped configuration, with surfaces 202 and 204 generally in parallel. Surface 206 lays perpendicular to and in between surfaces 202 and 204. FIG. 2A also illustrates the inner surfaces of the base comprising 212, 214, and 216, and in a V shaped configuration. Surfaces 212 and 214 converge toward each other to form a sharp angle, with the wider part of the V shape at the opening of the base, and narrower towards surface 216. Surface 216 intersects the convergence of surfaces 212 and 214, and is in general parallel to the outer surface of 206. It can be seen from FIG. 1A that the profile of the base has a U shaped outer surface, and a V shaped inner surface in which it receives an edge portion of a partition.

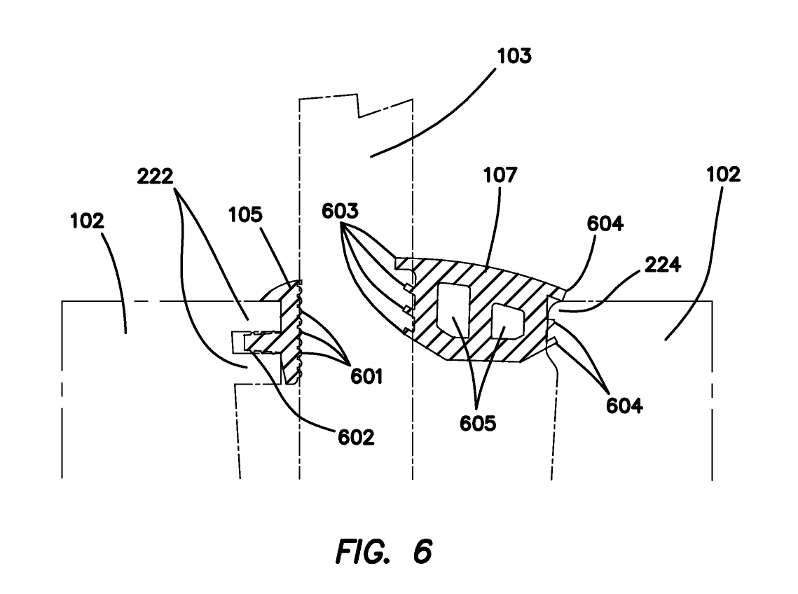

FIGS. 2A and 2B also illustrates two protrusions 222 and 224, one along each opening edge of the base 202, in two and three dimensional views. The main purpose of the protrusions is to provide an anchoring mechanism for installing the concealing strips. The shape and number of protrusions are not limited to those illustrated in FIGS. 2A and 2B. The protrusions in general comprise shapes that are geometrically inverse of the shapes of the concealing strips. An exemplary embodiment is illustrated in FIG. 6 in more details later in the specification.

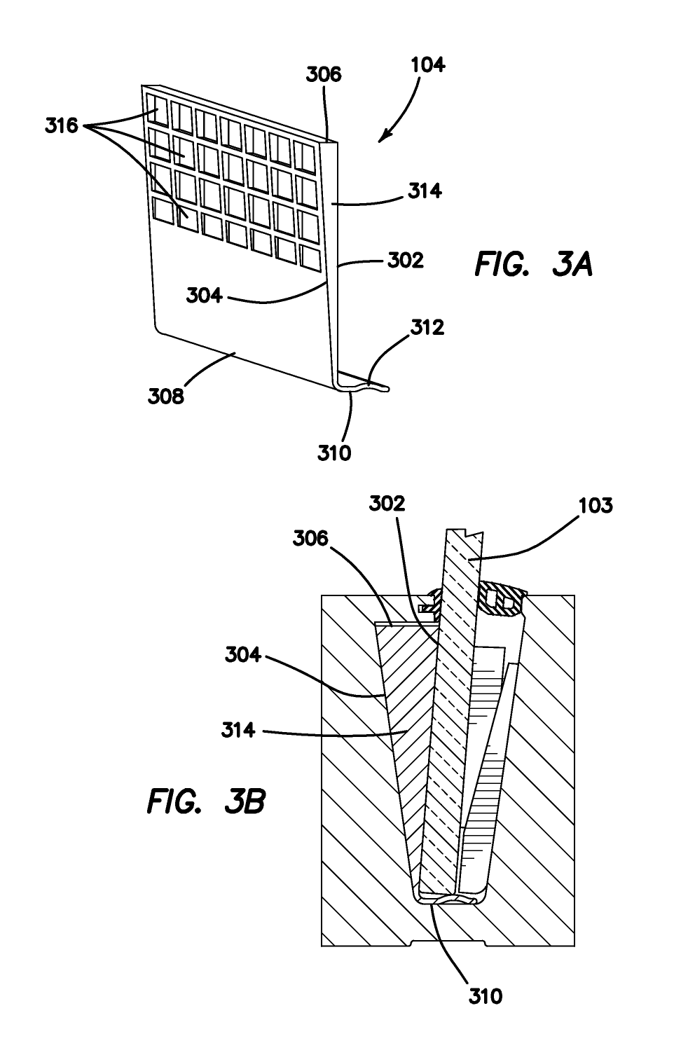

FIG. 3A illustrates a perspective side view of a receiving plate 104. The receiving plate 104 is inserted into the base 102 to provide cushion for the partition as well as to angle the partition as needed.

The receiving plate 104 comprises two arms, 310 and 314, generally forming a L shape. The shorter arm 310 is fitted immediately above the bottom inner surface of the base 216. The longer arm 314 is fitted against one of the inner side walls of the base, 212 or 214. The two arms meet along the edge 308.

The short arm 310 comprises an arch 312 slightly away from the bottom of the base 216. The arch created a small channel between the receiving plate and the bottom surface of the base. Fluid, such as rain water, can be drained out of the clamping system via this channel.

The longer arm 314 comprises surface areas defined by edges 302, 304, and 306. The three edges forms an inverted triangular profile, with 306 as the base edge extending along the opening of the base. Edges 302 and 304 form the two sides of the inverted triangle, converging towards edge 308 along the bottom of the base.

The width of edge 306 determines the angle between edges 302 and 304. The partition rests on the short arm 310 and against the long arm 314 along the surface determined by edge 302. Therefore the tilt of the partition is influenced by the width of edge 306. In an exemplary embodiment illustrated in FIG. 3B, the width of edge 306 increases, the angle between 302 and 304 increases, and therefore the partition is tilted away from the long arm of the receiving plate 314 towards the opposing side surface of the base.

The width of the edge 306 can be predetermined during the manufacturing process, if a certain tilt of the partition installation is already known based on design. Alternatively, the receiving plate can be made of flexible material, so that the width of the edge 306 can change slightly by compression or decompression. This property allows for minor adjustment of the tilt or orientation of the partition material during installation. It also allows for small degrees of flexibility due to the expansion or shrinkage of the partition material from temperature variation. FIG. 3A also illustrates an exemplary implementation of cut outs 316 along the surface of the long arm determined by the edge 304. These cut outs allows for further flexibility of the receiving plate, by strategically and systematically “weaken” the material, and therefore making it easier to compress or to decompress.

The length of the receiving plate determined by edge 308 in FIG. 3A can also vary. In some cases, edge 308 shares the same length of the base, and a single long receiving plate lined the inner surface of the base. In other cases, edge 308 can be short, and each receiving plate is an independent discrete unit. Many units of receiving plates can be used along various locations of the partition installation. This is particularly useful when the partition has some sort of curvature or irregular shape.

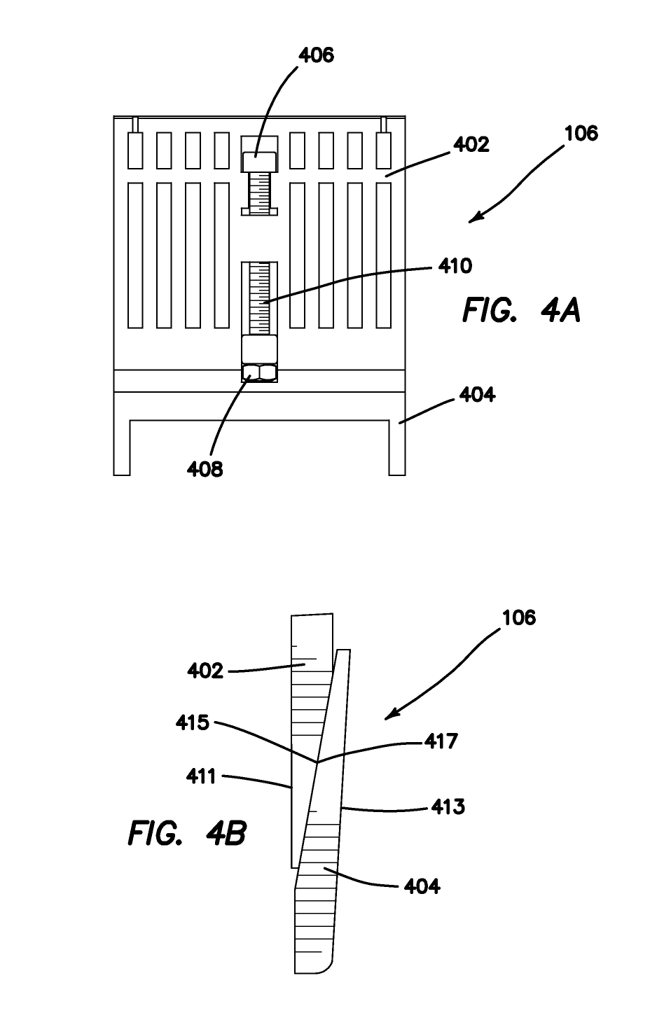

FIG. 4A and FIG. 4B illustrates a frontal and a side view of a wedge 106. The wedge 106 comprises an upper block piece 402 and a lower block piece 404. FIG. 4B illustrates a profile of the two blocks and their relation. When the wedge is installed, surface 411 from the upper block 402 is in direct contact with a partition. Surface 413 from the lower block is in direct contact with a inner surface of the base. Surface 415 from the upper block 402 and surface 417 from the lower block are in contact with each other, and can be configured to slide against each other in a controlled manner.

FIG. 4A illustrates a frontal view of the wedged 106, with an upper block 402 largely occluding the lower block 404, and only a small lower portion of the block 404 is shown. The upper block 402 houses a long screw 406. The screw 406 is connected to a receiving nut 408 housed in the lower block 404. Therefore the screw 406 connects the upper and lower block pieces 402 and 404. The relative position between the screw 406 and its receiving nut can be read from the markings 410 on the screw.

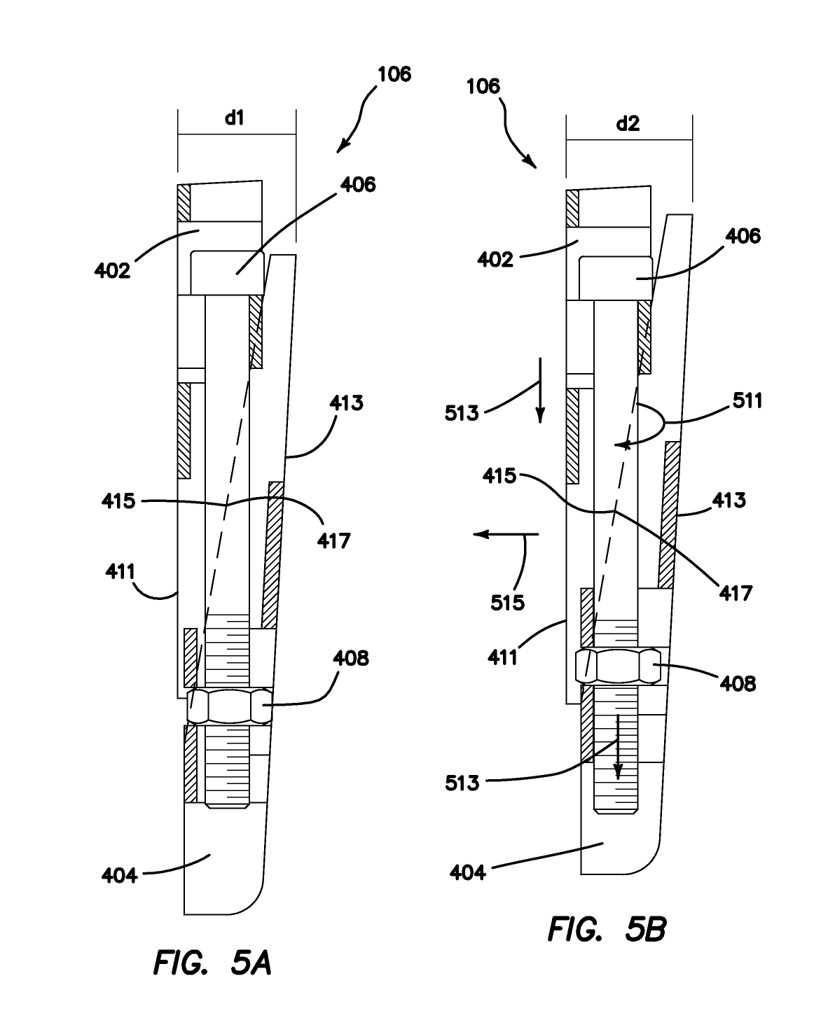

FIGS. 5A and 5B illustrate the operation of the wedge 106 by detailing the relative movements of the screw and the change of surface relations among various components of the wedged.

FIG. 5A illustrates the profile of the wedge 106 when the screw 406 is in a relatively raised position with respect to its receiving nut 408. The upper and lower block pieces are in contact with each other along their respective surfaces 415 and 417. The distance d1 represents the horizontal distance between surfaces 411 and 413, or the width of the wedge 106.

FIG. 5B illustrates the profile of the wedge 106 when the screw 406 is in a relatively lowered position with respect to its receiving nut 408. As the screw is rotated downward as shown by the arrow 511, the upper block piece 402 slides downward as shown by the arrow 513 by sliding down against the lower block piece 404 along the surfaces determined by 415 and 417. As a result, the distance d2 between surfaces 411 and 413 increases, or the width of the wedge 106 increases.

As discussed in the previous figure, surface 411 is in direct contact with the partition. Surface 413 is in direct contact with the inner surface of the base. In essence, the wedge 106 asserts physical pressure between the partition and the base, for the purpose of securing the partition in the base. The amount of pressure asserted by the wedge is directly related to the position of the screw and its receiving nut, which controls the width of the wedge by sliding the upper and lower block pieces against each other.

FIG. 6 is a schematic drawing which illustrates the side view of the upper edges of the base 102, with the partition 103 installed, and with both concealing strips 105 and 107 in place.

One exemplary protrusions 222 is shown along one of the opening edges of the base, with two prongs. The concealing strip 105, in this particular example, has one prong which fits into the two prongs from the protrusion 222. The concealing strip 105 further comprises tentacles 601 and 602, which increase friction between the strip and the partition or the base. The purpose is to further secure the strip in its intended position.

Another exemplary protrusions 224 is shown along the opposing opening edges of the base, with one prong. The concealing strip 107 is much wider in its profile and therefore fills up a wider gap between the partition and the base. The concealing strip 107 comprises tentacles 604 on one end that function to grip the protrusion 224. The strip 107 comprises tentacles 603 on the other end that grip onto the surface of the partition. The strip 107 further comprises cut outs 605 which facilitate the compression and decompression of the strip 107 during installation.

It should be noted that the number of prongs from the protrusion on the edges of the base, or from the concealing strips can vary, so long as they are generally configured with profiles that are geometrically inverse of one another. The purpose of the concealing strips is to create a barrier and fill up the gap or space between the partition and the base. The concealing strips 105 and 107 can be made from flexible materials so that they can be easily compressed or decompressed.

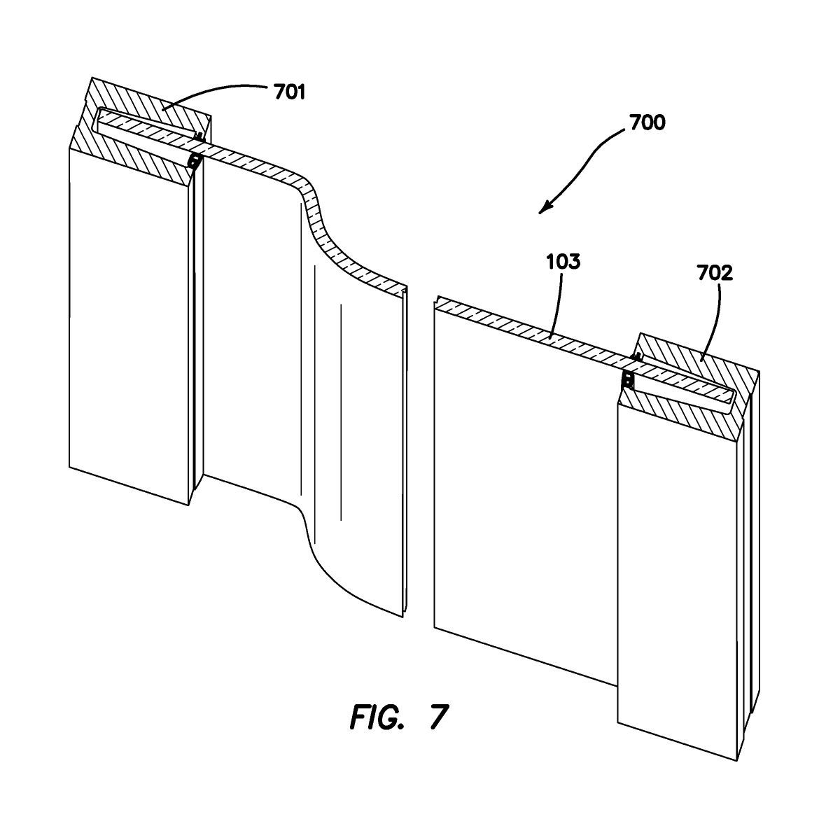

FIG. 7 illustrates an example 700 where the bases 701 and 702 of the present clamping system are installed in an upright position. The partition 103 in this particular example can be of irregular shape so long it is held at various locations to secure its design. It should be noted that the base of the present clamping system can also be installed by lying on either one of its sides, on the ground or against a wall above the ground, to accommodate installations with horizontal partitions.

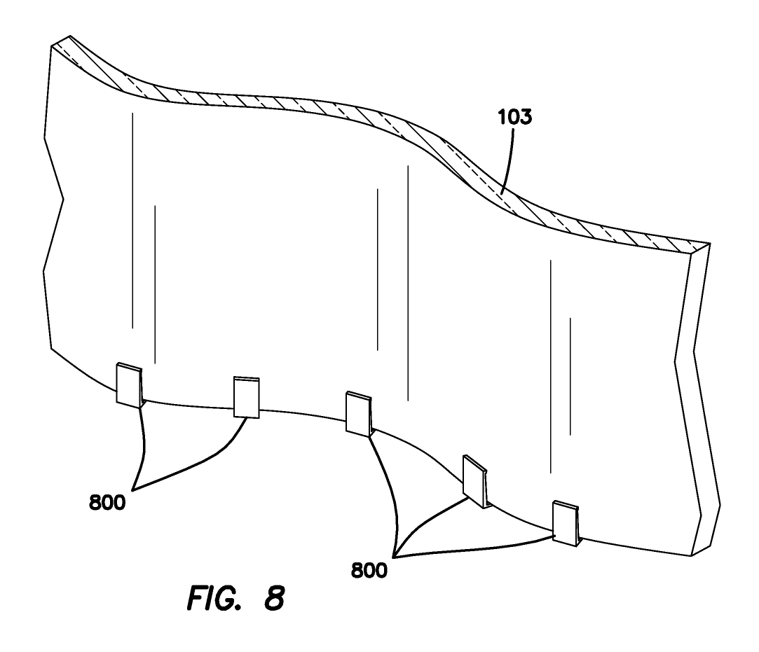

FIG. 8 illustrate and example where the partition 103 is installed with multiple clamping units 800 to accommodate its complex design.

The length of the base can also be shortened to that of a single wedge. In those cases, the clamping system comprises a series of clamping units. Each unit is comprised of a base, a receiving plate, a wedge and concealing strips. For a complex design, it may not be feasible to pre-fabric an extended base, which increases both the weight, costs and difficulties in installation. The clamping units can greatly improve the flexibility and cost effectiveness of the railing installation, and accommodate complex designs at the same time.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to achieve the desired features of the present invention. Also, a multitude of different constituent module names other than those depicted herein can be applied to the various partitions.

Although the invention is described above in terms of various exemplary embodiments and implementations, it should be understood that the various features, aspects and functionality described in one or more of the individual embodiments are not limited in their applicability to the particular embodiments with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A concealable clamping system for mounting partitions, comprising:
a base with an opening to receive an edge portion of a partition;
at lease one receiving plate fitted inside of the opening of the base to orient the edge portion of the partition;
at least one adjustable wedge to secure the edge portion of the partition against the receiving plate and against an inner surface of the base;
a first removable concealing strip fitted between a first edge of the base and the partition; and
a second removable concealing strip fitted between a second edge of the base and the partition.

2. A concealable clamping system of claim 1, wherein the base further comprises
an outer surface with an U shaped profile configured to have a bottom surface and two side walls that are generally parallel to one another; and
an inner surface with a V shaped profile configure to have a bottom surface and two side walls that converge towards the base.

3. A concealable clamping system of claim 1, wherein
a first inner edge along the opening of the base comprises at least one protrusion to receive the first removable concealing strip; and
a second inner edge along the opening of the base comprises at least one protrusions to receive the second removable concealing strip.

4. A concealable clamping system of claim 3, wherein the protrusions on the inner edges of the base and the concealing strips are configured with profiles that are geometrically inverse of one another, so as to retain the concealing strips in their respective positions.

5. A concealable clamping system of claim 1, wherein the first and second concealing strips further comprise at least one tentacle.

6. A concealable clamping system of claim 1, wherein the first and second concealing strips further comprise at least one cutout to increase flexibility during installation.

7. A concealable clamping system of claim 1, wherein the receiving plate further comprises
a long arm with generally an up-side-down triangular profile towards the bottom surface of the base; and
a short arm with an arch creating a channel between the short arm and the bottom surface of the inner surface of the base.

8. A concealable clamping system of claim 7, wherein the orientation of the partition can be selectively adjusted by changing the triangular profile of the long arm of the receiving plate.

9. A concealable clamping system of claim 7, wherein the long arm of the receiving plate further comprise at least one cut out to increase flexibility during installation.

10. A concealable clamping system of claim 1, wherein the adjustable wedge is installed between the edge portion of the partition and the side wall of the inner surface of the base.

11. A concealable clamping system of claim 1, wherein the adjustable wedge further comprises an upper block and a lower block jointly held together by a screw housed in the upper block and a receiving nut housed in the lower block.

12. An adjustable wedge of claim 11, wherein a width of the wedge is determined by sliding the upper block against the lower block by adjusting specific positions of the screw with respect to the nut along a predetermined path.

13. A concealable clamping system of claim 1, wherein the partition can be selectively angled by adjusting the width of the wedge against the long arm of the receiving plate along various locations.

14. A concealable clamping system of claim 1, wherein the base can be installed to receive either a horizontal or a vertical edge of a partition.

15. A concealable clamping system for mounting partitions comprising multiple clamping units, wherein each clamping unit comprises:
a base with an opening to receive an edge portion of a partition;
at lease one receiving plate fitted inside of the opening of the base to orient the edge portion of the partition;
at least one adjustable wedge to secure the edge portion of the partition against the receiving plate and against an inner surface of the base;
a first removable concealing strip fitted between a first edge of the base and the partition; and
a second removable concealing strip fitted between a second edge of the base and the partition.

16. A concealable clamping system for mounting partitions comprising multiple clamping units, wherein each clamping unit comprises:
a base with an opening to receive an edge portion of a partition;
at lease one receiving plate fitted inside of the opening of the base to orient the edge portion of the partition;
at least one adjustable wedge to secure the edge portion of the partition against the receiving plate and against an inner surface of the base;
at least one concealing strip fitted between an edge of the base and the partition.

17. A concealable clamping system for mounting partitions of claim 16, wherein the receiving plate comprises a U shaped profile covering the entire edge portion of the partition continuously across multiple clamping units.
